(19) United States
(12) Patent Application Publication
(10) Pub. No.: US 2007/0300260 A1
(43) Pub. Date: Dec. 27, 2007

(54) METHOD, SYSTEM, DEVICE AND COMPUTER PROGRAM PRODUCT FOR GENERATING AND DISTRIBUTING MEDIA DIARY PODCASTS

(75) Inventors: Jukka A. Holm, Tampere (FI); Juha Arrasvuori, Tampere (FI); Antti Eronen, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION, Espoo (FI)

(21) Appl. No.: 11/425,785

(22) Filed: Jun. 22, 2006

(51) Int. Cl. H04N 7/20; H04N 5/445; G06F 13/00; G06F 3/00

(52) U.S. Cl. 725/47; 725/39; 725/44; 725/63

(57) ABSTRACT

A method, device and computer program product are provided for enabling a user to semi-automatically create a media diary or media blog associated with one or more media items consumed by the user during a given period of time. A method, apparatus, system and computer program product are further provided for distributing a corresponding media podcast that takes into consideration the network traffic, the storage space of the network entity responsible for providing access to the media podcast, the storage space of a mobile terminal associated with a party subsequently downloading the media podcast, and the fact that the entity receiving the media podcast may already have access to one or more of the media items associated with the media podcasts.

### FIELD

Exemplary embodiments of the present invention relate, generally, to media diaries and, in particular, to creating and selectively uploading and downloading media diary podcasts.

### BACKGROUND

One way for an individual to share his or her thoughts about various media items (e.g., songs, movies, eBooks, music videos, TV show episodes, etc.) is to create a media diary of the media items he or she has consumed (e.g., listened to, watched, read, etc.) over a given period of time. For example, the individual may want to share with others all of the songs he or she listened to while traveling to the beach on vacation. The media diary may include a list of the songs, as well as a running commentary on the songs, which may include, for example, a description of how a particular song made the person feel or what he or she was doing when the song was playing.

The creation of such a media diary may, however, be rather time-consuming and tedious, since the individual would be required to manually identify and record each of the media items consumed, compile the media items into the desired order, and add any voice-overs desired. This is particularly true where the media diary is created on a mobile terminal (e.g., a cellular telephone, personal digital assistant (PDA), laptop, pager, and the like) having limited input methods and a small display screen. A need, therefore, exists for a quick and simple way to create media diaries associated with a user's media consumption.

Podcasting has also gained popularity over time. Podcasting refers to the distribution of multimedia files over the Internet, using, for example, Really Simple Syndication (RSS) or Atom syndication formats, for playback on a mobile terminal. The term “podcast” refers to both the content delivered and the method of delivering it. Podcasting can be distinguished from the simple download or real-time streaming of multimedia content by the fact that new content can be automatically delivered to a podcast subscriber on a regular basis. For example, an individual may have a subscription to a particular “show” or podcast. He or she would then automatically receive each new episode of the podcast, for example, every day, week, month, or the like.

In the example discussed above where an individual creates a media diary, podcasting may be one manner in which the user can distribute his or her media diary, in addition to the actual media items consumed. In other words, a media diary podcast may be created that would enable a purchaser/subscriber to consume the same media items in the same, or similar, order and manner in which the creator consumed the media items, as well as listen to any commentary provided by the media diary creator.

Several issues arise, however, in relation to the uploading and downloading of media diary podcasts including one or more media items. These issues include, for example, the legal issues surrounding the improper dissemination of copyrighted material, and the increase in network traffic and use of storage space involved in the uploading and downloading of multiple media items. In addition, an issue may often arise where a party who desires to download a media diary podcast already owns one or more of the media items of the media diary podcast and, therefore, would likely prefer not to download and, more likely prefer not to be charged for downloading, the media items he or she already owns.

A need, therefore, exists for a technique for distributing media diary podcasts in a manner that takes into consideration each of these issues.

### BRIEF SUMMARY

In general, exemplary embodiments of the present invention provide an improvement over the known prior art by, among other things, providing a method by which a user can semi-automatically create a media diary, or media blog, associated with one or more media items consumed by the user during a given period of time. Exemplary embodiments further provide a technique for distributing a corresponding media diary podcast that takes into consideration the network traffic, the storage space of the network entity responsible for providing access to the media diary podcast, and the storage space of a mobile terminal associated with a party subsequently downloading the media diary podcast. The technique of exemplary embodiments further provides an improvement over the known prior art by adjusting a charge associated with the download of a particular media diary podcast where the party downloading the media diary podcast already possesses or has access to certain ones of the media items associated with the media diary podcast. The foregoing techniques for uploading, downloading and adjusting a charge associated with the download may likewise be used for downloading audio albums, or similar media files, comprising one or more music tracks, or similar media items.

In accordance with one aspect, a method is provided of creating a media diary. In one exemplary embodiment, the method includes: (1) enabling a user to consume one or more media items; (2) associating an identification with respective media items consumed; (3) storing context information associated with respective media items consumed; and (4) constructing a media diary comprising the identification and the context information associated with respective media items consumed.

In one exemplary embodiment, the method further includes: enabling the user to create a narration recording; assigning an identification to the narration recording; and determining a time relative to a beginning of the media diary associated with the narration recording. According to this exemplary embodiment, constructing a media diary may further comprise constructing a media diary comprising the narration recording, the identification associated with the narration recording, and the time relative to the beginning of the media diary associated with the narration recording.

Alternatively, in another exemplary embodiment, the method may further include enabling the user to select a type of media item for which to create a media diary. According to this exemplary embodiment, associating an identification with respective media items consumed comprises associating an identification with respective consumed media items of the type selected, and storing context information associated with respective media items consumed comprises storing context information associated with respective consumed media items of the type selected.

In accordance with another aspect, a device is provided that is configured to create a media diary. In one exemplary embodiment, the device includes a processor and a memory in communication with the processor, wherein the memory stores an application that is executable by the processor and is configured, upon execution, to: (1) enable a user to consume one or more media items; (2) associate an identification with respective media items consumed; (3) store context information associated with respective media items consumed; and (4) construct a media diary comprising the identification and the context information associated with respective media items.

In one exemplary embodiment, the device further includes a microphone in communication with the processor that is configured to enable the user to create a narration recording. In another exemplary embodiment, the device further includes a user interface configured to enable the user to select a type of media item for which to create a media diary.

In accordance with yet another aspect, a computer program product is provided for creating a media diary. The computer program product contains at least one computer-readable storage medium having computer-readable program code portions stored therein. The computer-readable program code portions of one exemplary embodiment include: (1) a first executable portion for enabling a user to consume one or more media items; (2) a second executable portion for associating an identification with respective media items consumed; (3) a third executable portion for storing context information associated with respective media items consumed; and (4) a fourth executable portion for constructing a media diary comprising the identification and the context information associated with respective media items.

According to another aspect, a method is provided for distributing a media file associated with one or more media items. In one exemplary embodiment, the method includes: (1) receiving, at a receiving entity, an identification associated with at least one media item of the media file; (2) determining whether the at least one media item was previously accessible by the receiving entity; and (3) requesting and receiving only those of the at least one media item for which it was determined that the media item was not previously accessible by the receiving entity.

In one exemplary embodiment, the method may further include repeating the steps of receiving an identification, determining whether the at least one media item was previously stored, and requesting and receiving only those of the at least one media item for which it was determined that the media item was not previously stored by the receiving entity, for each of the one or more media items of the media file. The method of this exemplary embodiment may further include receiving context information associated with respective media items of the media file. The method may further include receiving one or more narration recordings associated with the media file, wherein respective narration recordings comprise a time relative to a beginning of the media file associated with the narration recording.

According to yet another embodiment, the method may further include accessing one or more media items for which it was determined that the media item was previously accessible by the receiving entity; and combining the identification associated with respective media items of the media file, the at least one media item requested and received, the one or more media items accessed, the context information associated with respective media items of the media file and the one or more narration recordings into a media podcast file.

Alternatively, the method of one exemplary embodiment may further include storing the identification associated with respective media items of the media file, the at least one media item requested and received, the context information associated with respective media items of the media file and the one or more narration recordings, separately from the one or more media items for which it was determined that the media item was previously accessible by the receiving entity. The method of this exemplary embodiment may further include receiving a request for a podcast of the media file from a requester; determining which of the one or more media items of the media file were previously accessible by the requester; and assembling a media podcast based at least in part on the determination of which of the one or more media items of the media file were previously accessible by the requester. The method of this exemplary embodiment may further include adjusting a charge associated with downloading the media podcast based at least in part on the determination of which of the one or more media items of the media file were previously accessible by the requester. In addition, the method of this exemplary embodiment may also further include enabling a user to remove one or more media items of the media file; and adjusting the price associated with the download of the media podcast, based at least in part on the one or more media items removed by the user.

In one exemplary embodiment the receiving entity comprises a network entity configured to provide one or more media podcasts for downloading. In an alternative embodiment, the receiving entity comprises a mobile device configured to access and download one or more media podcasts. The method of this exemplary embodiment may further include adjusting a price associating with downloading a media podcast corresponding with the media file based at least in part on the determination of whether the at least one media item was previously accessible by the mobile device.

In accordance with yet another aspect, an apparatus is provided for distributing a media file associated with one or more media items. In one exemplary embodiment, the apparatus includes a processor and a memory in communication with the processor, wherein the memory stores an application that is executable by the processor and is configured, upon execution, to: (1) receive, at a receiving entity, an identification associated with at least one media item of the media file; (2) determine whether the at least one media item was previously accessible by the receiving entity; and (3) request and receive only those of the at least one media item for which it was determined that the media item was not previously accessible by the receiving entity.

In accordance with another aspect, a system is provided for distributing a media file associated with one or more media items. In one exemplary embodiment, the system includes a transmitting entity configured to transmit an identification associated with at least one media item of the media file; and a receiving entity configured to receive the at least one identification and to determine whether the at least one media item was previously accessible by the receiving entity. According to this exemplary embodiment, the receiving entity is further configured to request and receive, from the transmitting entity, only those of the at least one media item for which it was determined that the media item was not previously accessible by the receiving entity.

In accordance with yet another aspect, a computer program product is provided for distributing a media file associated with one or more media items. The computer program product contains at least one computer-readable storage medium having computer-readable program code portions stored therein. The computer-readable program code portions of one exemplary embodiment include: (1) a first executable portion for receiving, at a receiving entity, an identification associated with at least one media item of the media file; (2) a second executable portion for determining whether the at least one media item was previously accessible by the receiving entity; and (3) a third executable portion for requesting and receiving only those of the at least one media item for which it was determined that the media item was not previously accessible by the receiving entity.

### BRIEF DESCRIPTION OF THE SEVERAL VIEWS OF THE DRAWING(S)

Having thus described exemplary embodiments of the invention in general terms, reference will now be made to the accompanying drawings, which are not necessarily drawn to scale, and wherein:

FIG. 1 is a flow chart illustrating the steps which may be taken in order to semi-automatically create a media diary associated with one or media items consumed by a user in accordance with exemplary embodiments of the present invention;

FIG. 2 is a flow chart illustrating the steps which may be taken in order to upload a media diary podcast in accordance with exemplary embodiments of the present invention;

FIG. 3 is a flow chart illustrating the steps which may be taken in order to download a media diary podcast in accordance with exemplary embodiments of the present invention;

FIG. 4 is a block diagram of one type of system that would benefit from exemplary embodiments of the present invention;

FIG. 5 is a schematic block diagram of an entity capable of operating as a Podcast Provider in accordance with exemplary embodiments of the present invention; and

FIG. 6 is a schematic block diagram of a mobile station capable of operating in accordance with an exemplary embodiment of the present invention;

### DETAILED DESCRIPTION

Exemplary embodiments of the present invention now will be described more fully hereinafter with reference to the accompanying drawings, in which some, but not all embodiments of the inventions are shown. Indeed, exemplary embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, exemplary embodiments of the present invention provide a method for semi-automatically creating a media diary or media blog that represents a user's media consumption over a given period of time. In particular, according to exemplary embodiments, a user can instruct his or her mobile terminal to automatically create a media diary or blog that tracks all of the media items that the user consumes over a certain period of time (e.g., a day, week, month, season, etc.). The mobile terminal will then keep a record of the identifications associated with each media item consumed, as well as context and timing information associated with respective media items. The user may further create voice-over speech, or narration, recordings to be included in the media diary in between or even on top of the media items. When the user wishes to stop tracking his or her media consumption (or when the specified period of time as elapsed), the mobile terminal will compile the media diary and upload it as a media diary podcast to a network entity, such as a server, from which it can be subsequently downloaded by other parties.

Exemplary embodiments of the present invention further provide an improved method of uploading and downloading the media diary podcasts corresponding, for example, with the media diaries created in the manner discussed above, wherein only those media items that were not previously accessible by the receiving party (i.e., the network entity where the media diary podcast is being uploaded, or the mobile terminal where the media diary podcasts is being downloaded) are transmitted to the receiving party. In addition to reducing the amount of network traffic associated with the upload and download of media diary podcasts and the amount of storage required to store the media diary podcast, exemplary embodiments enable a party requesting a media diary podcast to receive the podcast without being re-charged for media items he or she already owns or has licensed.

A similar technique may likewise be used where an individual wishes to purchase and download a music or audio album (also referred to more generally as a media file), where the user already owns one or more songs or music tracks of the audio album (i.e., the media items associated with the media file or audio album). In other words, the purchaser may only download and, therefore, only pay for, those music tracks or songs of the album that he or she did not already own.

### Method of Creating Media Diary

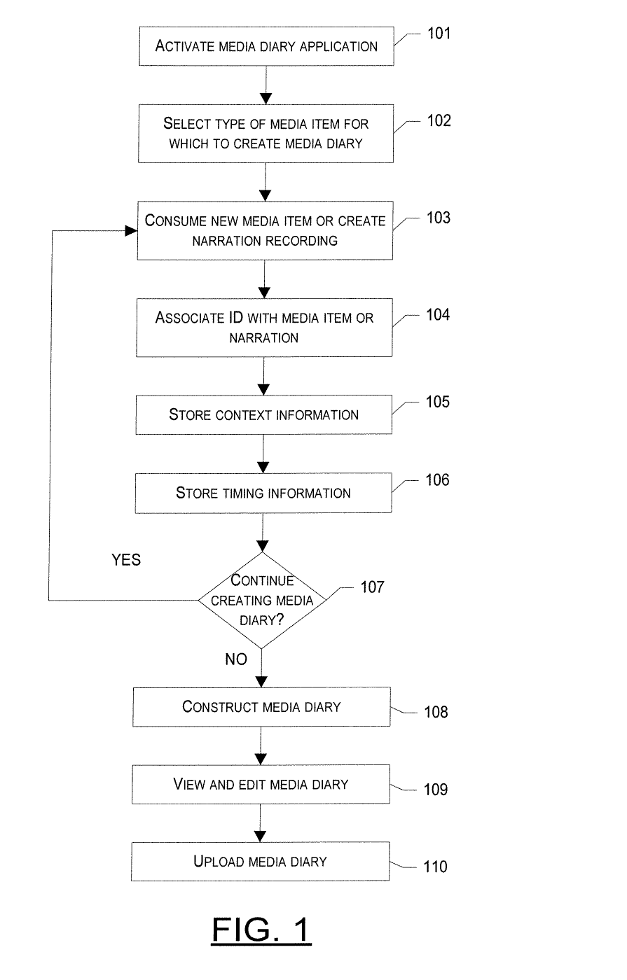

Reference is now made to FIG. 1, which illustrates the steps which may be taken in accordance with one exemplary embodiment of the present invention in order to create a media diary or media blog corresponding with one or more media items consumed by a user during a given period of time. As shown, the process may begin at Step 101, where a user activates or starts a media diary application operating on his or her mobile terminal in order to begin creation of the media diary. In particular, the media diary application may include one or more computer program instructions stored in memory and executed by a processing element, such as a computing device, operating on the mobile terminal, wherein, upon execution, the media diary application is configured to perform the steps described herein for automatically creating the media diary. In one exemplary embodiment, in order to activate the media diary application, the user may select an icon associated with the media diary application that is displayed on a display screen of the mobile terminal. Alternatively, or in addition, the media diary application may be capable of being activated by actuating a particular key of the mobile terminal keypad (soft or hard) that is associated with the media diary application.

Regardless of the manner in which the media diary application has been activated, upon activation, the user of one exemplary embodiment may be given the opportunity to select, in Step 102, the type of media item for which he or she would like to create a media diary. For example, the user may be asked to select between tracking or cataloging the music files, video files, still photographs or eBooks, to name a few, consumed by the user. Where, for example, the user selects music files as the type of media item for which to create a media diary, in the following steps illustrated in FIG. 1, the media diary application will disregard the media items of the other types (i.e., video files, still photographs or eBooks) that are consumed by the user, and will focus solely on the music files consumed (i.e., listened to) by the user.

In one exemplary embodiment, not shown, the user may further be given the opportunity to specify how long the media diary application should stay activated. In other words, the user may be able to specify the length of time for which he or she desires to create the media diary. For example, the user may indicate that he or she would like to create a media diary for all of the videos he or she watches throughout the month of May. As another example, he or she may specify that he or she would like to create a media diary associated with all of the eBooks he or she reads over the entire summer (i.e., the months of May, June, July and August). Alternatively, the length of time for which the media diary application should stay active may be based on a maximum length of the resulting media diary podcast, discussed in more detail below. For example, or in addition, the user may specify that, for example, the resulting media diary podcast should not be longer than one hour. In this instance the media diary application may keep track of the length of time associated with each media item consumed, as well as each narration, or voice-over speech, recording, and then stop tracking/cataloging media items once the maximum podcast length has been reached. In another exemplary embodiment, the media diary application may remain activated until the user deactivates it, for example, by again actuating the same or different key, or selecting the same or different icon. In another alternative embodiment, a default length of time may be used unless the user specifically specifies otherwise.

In yet another exemplary embodiment, not shown, the user may further specify that he or she will provide ratings to each of the media items consumed and that only those media items above a certain rating should be included in the media diary created. The ratings may be given, for example, on a scale of one to five, where one is the lowest rating and five is the highest. The user may instruct the media diary application to add only those media items to which the user has given a rating of three or higher to the media diary. According to this exemplary embodiment, the user is able to automatically create a media diary of those media files that, in his or her opinion, are good. In addition, in one exemplary embodiment, the user may be able to adjust the rating threshold that media items must be given in order to be included in the media diary. In yet another exemplary embodiment, all of the media items may be included, along with their respective ratings, in the media diary, and the party downloading the corresponding media diary podcast, discussed below, may be capable, for example, of deselecting all media items with a rating below a four from the podcast. According to this exemplary embodiment, the downloading party can easily obtain a personal “top charts” media diary of the media items most preferred by the creator of the media diary.

In addition to the foregoing, the user may further be given the opportunity to specify whether he or she would like to include a short pause in between media items in the resulting media diary and, if so, what length. Where the user indicates that he or she would like to include a short pause (e.g., 2 seconds), this information will be taken into consideration when determining timing information associated with the various media items, discussed briefly below.

Once the various parameters for creating the media diary have been established, the user is then able to begin, in Step 103, consuming a new media item or creating a narration, or voice-over speech, recording. As used herein, the term “consuming” refers to any manner in which a particular media item is accessed and enjoyed, and its definition is dependent upon the type of media item to which it is referring. For example, consuming a music file may refer to playing the music file so that the user can listen to it, while consuming a still photograph or eBook may refer to displaying the photograph or the text of the eBook so that the user can view it. Similarly, consuming a video file may refer to playing the video file so that it can be viewed by the user.

According to exemplary embodiments of the present invention, when the user begins to consume a new media item of the type selected in Step 102, the media diary application will automatically associate, in Step 104, an identification (ID) with the media item consumed. Where, for example, the media item comprises an MP3 music file, the ID may include, for example, the artist and song name stored in the MP3's ID3 metadata field, or an acoustic fingerprint of the music file. Alternatively, where, for example, the media item comprises an eBook, the ID may include the name and author of the eBook. Where an ID is not readily available, in one exemplary embodiment, the media diary application may create, or request that the user create, an ID that can be associated with the media item.

Returning to Step 103, according to exemplary embodiments of the present invention, in addition to merely cataloging all of the media items consumed throughout a given period of time, a user may further be able to create a commentary or narration of the media items and include the commentary in the media diary. In particular, in Step 103, the user may create a narration, or voice-over speech, recording that can be played on top of or in between media items of the media diary. For example, a user may desire to include a statement that “This song will make you cry” prior to a particularly sappy song. As another example, the user may want to add a comment to “Look at that hot mama” at a certain point in a video. To create the narration recording, the user may merely speak into a microphone associated with the mobile terminal. The speech may be recorded into a narration recording file and, similar to the media item consumed, in Step 104, an identification may be associated with the narration recording file.

Continuing as illustrated in FIG. 1, in Step 105, the media diary application may store context information associated with the media item consumed and/or the narration recording created. As used herein, the term “context information” refers to any data or information that is associated with any aspect of the context in which the media item is consumed or the narration recording created. Context information may include, for example, information regarding the date and/or time when the item was consumed or the recording was created, the location at which the user was located when the media item was consumed or the recording was created (e.g., the global positioning system (GPS) coordinates associated with the location, or the name of the city and/or state in which the user was located), and/or information relating to the weather at the time and location the media item was consumed or the recording was created (e.g., temperature, amount of precipitation, etc.).

Next, in Step 106, timing information is associated with the media item and/or narration recording. In particular, a time relative to the beginning of the media diary that is associated with the media item or narration recording is determined. This may include, for example, the number of minutes and/or seconds that should elapse from the beginning of the media diary before the user recorded comment or the consumed media item should be played. In the instance where a user specified that he or she would like to have a short pause between all media items, or only specific media items (e.g., those between which there is no recorded speech), this information would be taken into consideration when associating a time with respective media items.

In addition to storing timing information relative to the beginning of the media diary, where the media item comprises a still image (e.g., a photograph), it may likewise be necessary to specify how long the still image should remain visible. This may include, for example, indicating either a time relative to the beginning of the media diary associated with when the still image should cease being viewable, or a length of time for which the still image should remain viewable.

In one exemplary embodiment, it may not be necessary to associate timing information with various media items of the media diary. In this exemplary embodiment, the media items may simply follow one after another within a predetermined time interval in the resulting media diary podcast. Alternatively, where, as discussed above, timing information is associated with the various media items, the user creating the media diary podcast may be able to create, for example, longer pauses between certain media files. In addition, with respect to the narration recordings, in one exemplary embodiment, in addition to (or instead of) storing timing information relative to the beginning of the media diary, timing information relative to the beginning of a particular media item with which the narration recording is associated may be stored. In this exemplary embodiment, voice-overs may be created that relate to specific media items, as well as independent voice-overs where no media item is being consumed.

Once a media item has been consumed and/or a narration recording has been created, it is determined, in Step 107, whether the user wishes to continue creating the media diary. As discussed above, this may be based on the length of time indicated by the user prior to Step 103, a default length of time, or a determination of whether the user has deactivated the media diary application. If it is determined that the user does wish to continue cataloging media items and/or creating narration recordings, the process returns to Step 103 where another media item is consumed and/or another narration recording is created. In one exemplary embodiment, the next media item consumed may be manually selected by the user. In an alternative embodiment, the next media item may be automatically consumed based, for example, on a random selection or a previously created playlist.

Alternatively, where it is determined that the user does not wish to continue creating the media diary, the process continues to Step 108 where the media diary is automatically constructed. In particular, the media diary application will compile, into a media diary file, all of the IDs associated with one or more media items consumed and/or narration recordings created, in the order in which they were consumed or created, the context information associated with respective media items and/or narration recordings, and the timing information associated with respective media items and/or narration recordings. Once the media diary file has been constructed, the user may, in Step 109, view and, if desired, edit the media diary. For example, the user may add an ID of another media item, delete the ID of a media item consumed, change the timing information associated with one or more media item or narration recordings or delete the ID associated with a particular media item or narration recording altogether, to name a few. Finally, where the user is satisfied with the media diary created, he or she can then, in Step 110, upload the media diary, for example, to a Podcast Provider, discussed in further detail below. Alternatively, or in addition, the user may store the media diary file to his or her mobile terminal, or delete it.

Based on the foregoing, exemplary embodiments of the present invention provide an improvement over the known prior art by eliminating the need for the user to manually determine, and list identification, context and/or timing information associated with media items consumed in order to create a media diary associated with those media items. In particular, exemplary embodiments provide a fast and convenient way to automatically catalogue and share the user's media consumption habits.

### Method of Uploading Media Diary Podcast

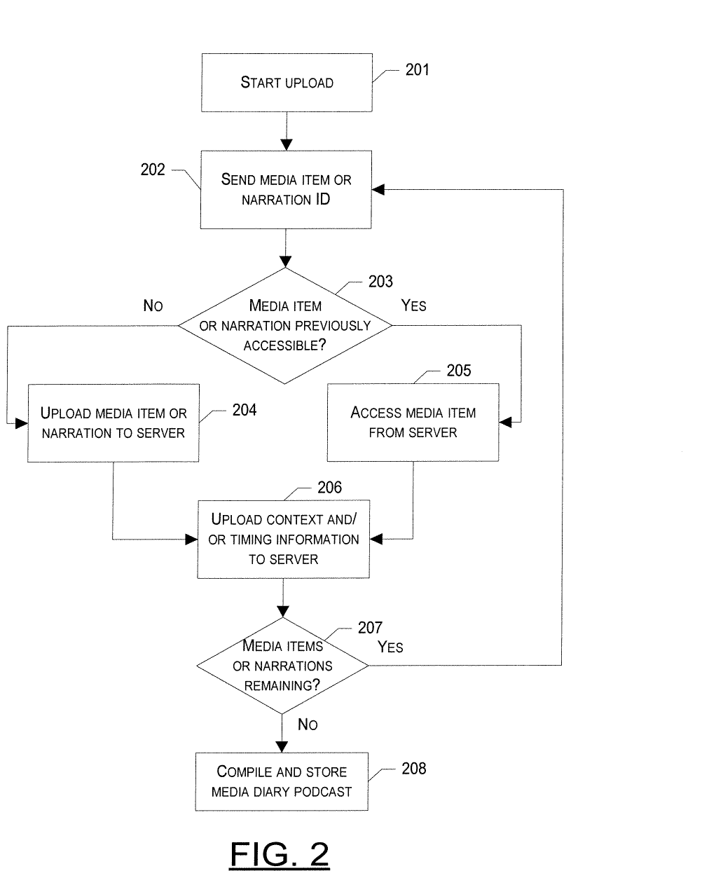

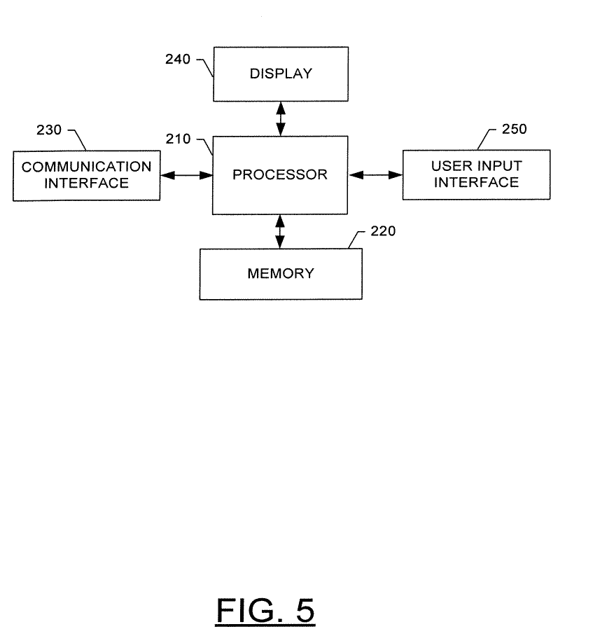

Reference is now made to FIG. 2, which illustrates the steps which may be taken in accordance with exemplary embodiments of the present invention in order to upload a media diary podcast corresponding, for example, with the media diary created according to the steps of FIG. 1. In one exemplary embodiment, the media diary podcast is uploaded from a transmitting entity, such as a mobile terminal, to a receiving entity, including, for example, a network entity, such as a server, configured to receive and store a plurality of podcasts that can be subsequently downloaded to other mobile terminals for consumption. The network entity so configured is referred to herein as a “Podcast Provider” and is discussed in more detail below with reference to FIG. 5.

As shown, once the upload is started in Step 201, either manually by the user or automatically upon completion of the media diary file, the ID associated with a first media item or narration recording (i.e., the commentary or voice-over speech recording) is transmitted to the Podcast Provider (Step 202). It is then determined, in Step 203, whether the media item or narration recording associated with the ID transmitted was previously accessible by the Podcast Provider. In particular, in one exemplary embodiment, the Podcast Provider may store a compilation of the IDs associated with each media item that was previously uploaded to the Podcast Provider (e.g., to the server or to a database accessible by the server). Upon receipt of the ID transmitted in Step 202, the Podcast Provider may compare the ID received with those stored in the compilation to determine if the Podcast Provider already has access to that particular media item.

Where it is determined that the Podcast Provider does not already have access to the corresponding media item or narration recording (as would most likely be the case for all narration recordings), the media item or recording is uploaded, in Step 204, to the Podcast Provider (e.g., to the server or database associated with the Podcast Provider). This may occur, for example, where the media item comprises a music file associated with a song by an obscure band or artists, a video file associated with an Indy film that was not widely disseminated, or a still photograph taken by the user associated with the mobile terminal.

Alternatively, where it is determined that the media item was previously accessible by the Podcast Provider (e.g., where the media item is a popular eBook), in one exemplary embodiment, the Podcast Provider will then, in Step 205, access the media item on the server or database itself In particular, in one exemplary embodiment, the Podcast Provider will, in essence, make a copy or duplicate of the media item for use with the media diary podcast currently being uploaded, while leaving the original media item for use in later media diary podcasts. In an alternative embodiment, discussed in more detail below, Step 205 is not performed until after a request is received to download the media diary podcast currently being uploaded. By uploading only those media items to which the Podcast Provider does not already have access, exemplary embodiments of the present invention provide an improvement over the known prior art by greatly reducing the amount of network traffic associated with the upload of media diary podcasts.

Once the first media item or narration recording has been retrieved, either from the mobile terminal or from the server or database associated with the Podcast Provider, in Step 206, the context information and/or the timing information is uploaded to the Podcast Provider. It is then determined, in Step 207, whether there are additional media items and/or narration recordings associated with the media diary podcast remaining. Where it is determined that there are additional media items and/or narration recordings to be retrieved (i.e., either uploaded or accessed), the process returns to Step 202, where the ID associated with the next media item or narration recording is transmitted to the Podcast Provider. This process continues until all of the media items and narration recordings associated with the media diary podcast have been retrieved by the Podcast Provider.

Where it is determined, in Step 207, that there are no remaining media items or narration recordings to be retrieved, the process continues to Step 208, where a media diary podcast file is created. In particular, in one exemplary embodiment, all of the discrete components of the media diary podcast (i.e., all of the IDs received, all of the media items and narration recordings uploaded from the mobile terminal, all of the context information and timing information also uploaded from the mobile terminal, as well as all of the media items accessed by the Podcast Provider on the server or database associated with the Podcast Provider) are compiled into one complete media diary podcast file that is stored by the Podcast provider. In one exemplary embodiment, the beginning of each media item of the media diary podcast is marked, for example, with a header associated with that media diary podcast, the media items are compiled in the appropriate order with the specified pauses, and the narration recordings are mixed in between or on top of the various media items at the time indicated by the timing information, either at the same or louder volume as the underlying media item. The resulting media diary podcast file, which may comprise, for example, an audio file, where the media diary contains only music and voice commentary, or a video file, in the instance where the media diary includes videos and still images viewable as a slideshow, is stored and ready to be downloaded by a requester.

In an alternative embodiment, not shown, the various files of the media diary podcast are stored separately until a request is received to download the media diary podcast. At this point (i.e., when a request is received), as discussed in more detail below, the Podcast Provider will first determine which of the media items and narration recordings of the media diary podcast must be downloaded to the requester. The Podcast Provider will then access only those previously accessible media items that it has determined must be downloaded and either compile the various components at that time (i.e., perform Step 208), or separately transmit the components to the mobile terminal, where they are then compiled. In other words, according to this exemplary embodiment, the Podcast Provider will not store duplicates of the media items previously accessible by the Podcast Provider. In contrast, it will only duplicate those that must be downloaded and only immediately prior to downloading. This exemplary embodiment of the present invention, therefore, provides a further improvement over the known prior art by greatly conserving storage space associated with the Podcast Provider.

### Method of Downloading Media Diary Podcast

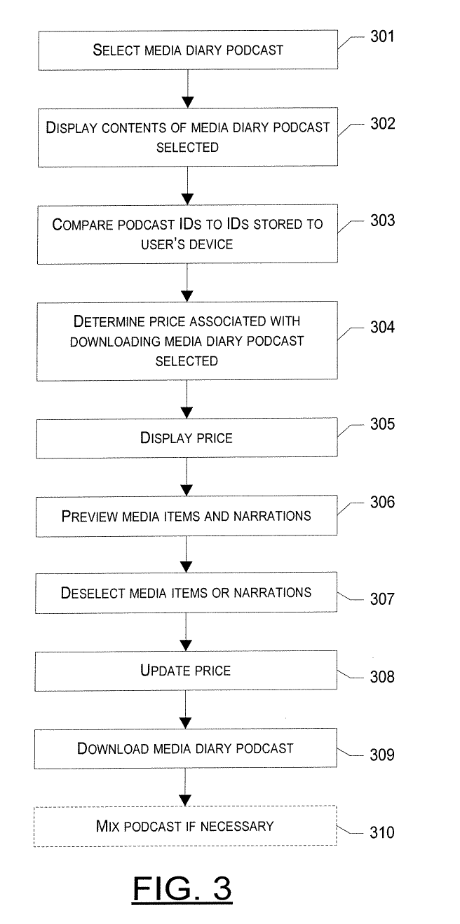

Once the media diary podcast has been uploaded to the Podcast Provider, in one exemplary embodiment, it can subsequently be downloaded in the manner illustrated in FIG. 3. In contrast to FIG. 2, in this exemplary embodiment, the transmitting entity may comprise the Podcast Provider, or similar server, while the receiving entity may comprise a mobile station. As shown, the process begins, in Step 301, where a user (or requester) selects a media diary podcast for downloading. In one exemplary embodiment, this step may be performed by using a web browser operating on the requester's mobile terminal to access a web site associated with the Podcast Provider, and on which a list of available media diary podcasts is provided. Alternatively, the requester may use a stand-alone application in order to access the web site on which the available media diary podcasts are listed. Upon selecting the media diary podcast, for example by highlighting the media diary podcast in the list provided, the contents of the media diary podcast may be displayed, in Step 302. In one exemplary embodiment, this may include displaying the names and types of the various media items included in the media diary podcast (e.g., a list of the song title and artist name for all of the music files of the media diary podcast).

In Step 303, a comparison is made of the media items included in the media diary podcast and those previously accessible by the requester's mobile terminal (e.g., the media items already stored on the mobile terminal). As was discussed above with regard to FIG. 2 and the process for uploading the media diary podcast to the Podcast Provider, this step may involve comparing the IDs associated with respective media items of the media diary podcast with the IDs associated with each of the media items stored on the mobile terminal. According to exemplary embodiments of the present invention, this step may be performed by either the mobile terminal or the Podcast Provider.

Once it is determined which of the media items have already been stored on or otherwise accessible by the mobile terminal, in Step 304, a price associated with downloading the media diary podcast is determined. In one exemplary embodiment this price is based only on those media items that have not been previously stored on the mobile terminal and which, therefore, must be downloaded at this time. The calculated price is then displayed to the requester in Step 305. Exemplary embodiments of the present invention, therefore, provide an improvement over the known prior art by allowing a requester to download a media diary podcast including media items the user already owns without requiring that the user re-purchase those media items.

At this point the requester may then preview the media items and narration recordings of the media diary podcast, in Step 306. If the requester decides that he or she does not like one or more of the media items included, would prefer not to have the media diary creator's running commentary, or would like to reduce the cost of the media diary podcast, the requester can, in Step 307, deselect those media items and/or narration recordings that he or she does not wish to download. In the instance where the requester does decide to deselect certain media items or narration recordings, the timing information associated with the remaining media items and narration recordings may be updated accordingly, such that there will not be any excessive gaps in the podcast following their removal. Once the user has deselected any media items or narration recordings desired, the price associated with downloading the media diary podcast is again determined or updated, in Step 308, this time taking into consideration the deselected media items and/or narration recordings. Assuming that the requester still wishes to download the media diary podcast, in Step 309, the media diary podcast is downloaded to the user's mobile terminal.

As discussed above, in one exemplary embodiment the media diary podcast may comprise a single file that was compiled by the Podcast Provider after uploading and/or accessing all of the various components. In this exemplary embodiment, Step 309 may comprise removing all of the media items and/or narration recordings which were either already accessible by the requester's mobile terminal or deselected by the requester, prior to transmitting a compiled media diary podcast (i.e., all of the IDs, all of the context information, all of the timing information and all of the requested media items and narration recordings compiled into one file where the narration recordings have already been mixed in between and/or on top of the appropriate media items based on the timing information).

Alternatively, as was also discussed briefly above, in another exemplary embodiment, the elements of the media diary podcast may be stored, and subsequently transmitted, separately by the Podcast Provider. According to this exemplary embodiment, after downloading the discrete elements of the media diary podcast, the mobile terminal may, in Step 310, be required to compile the media diary podcast.

As will be recognized by those of ordinary skill in the art, the method described above for downloading media diary podcasts, wherein the party downloading the podcast can avoid downloading and, therefore, purchasing, media items he or she already owns or has access to, can similarly apply to downloading music or audio albums from, for example, a music service. In particular, in this exemplary embodiment, the user may select a music album he or should would like to purchase, but for which he or she already possesses one or more songs or music tracks. This music service, or, in one exemplary embodiment, the mobile terminal associated with the user, may then compare the music tracks of the album with those already owned by the user, and then begin downloading, and purchasing, only those that the user does not already possess.

### Overall System and Mobile Device:

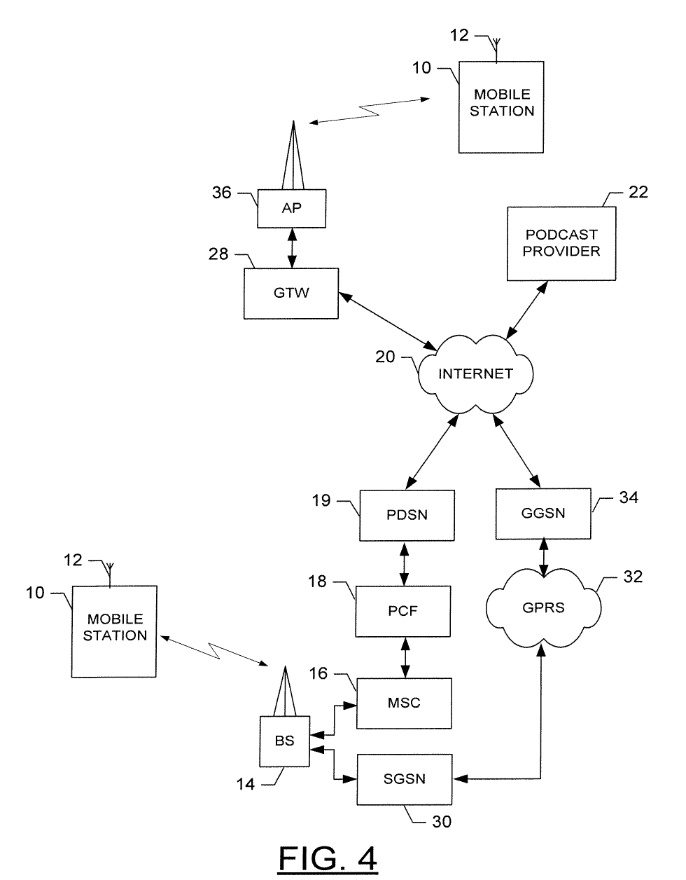

Referring to FIG. 4, an illustration of one type of system that would benefit from exemplary embodiments of the present invention is provided. As shown in FIG. 4, the system can include one or more mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. For example, the processing elements can include the Podcast Provider 22, discussed above and below. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 4) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements (e.g., a server associated with the Podcast Provider 22) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 4, in addition to or in lieu of coupling the mobile stations 10 to one or more processing elements (e.g., a server associated with the Podcast Provider 22) across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques. Further, the mobile station 10 and the processing elements can be coupled to one or more electronic devices, such as printers, digital projectors and/or other multimedia capturing, producing and/or storing devices (e.g., other terminals).

Referring now to FIG. 5, a block diagram of an entity capable of operating as a Podcast Provider 22 is shown in accordance with one embodiment of the present invention. The entity capable of operating as a Podcast Provider 22 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a Podcast Provider 22 can generally include means, such as a processor 210 connected to a memory 220, for performing or controlling the various functions of the entity. The memory can comprise volatile and/or non-volatile memory, and typically stores content, data or the like. For example, the memory typically stores content transmitted from, and/or received by, the entity including, for example, one or more media items previously uploaded from various entities, as well as one or more podcasts previously uploaded and/or compiled by the entity capable of operating as the Podcast Provider 22. Also for example, the memory typically stores software applications, instructions or the like for the processor to perform steps associated with operation of the entity in accordance with embodiments of the present invention. In particular, the memory may store instructions for the processor to, among other things, receive an ID associated with a media item of a media diary, determine whether the media item was previously accessible by the entity capable of operating as the Podcast Provider 22, and request and receive only those media items for which it was determined that the entity capable of operating as the Podcast Provider 22 did not previously have access.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

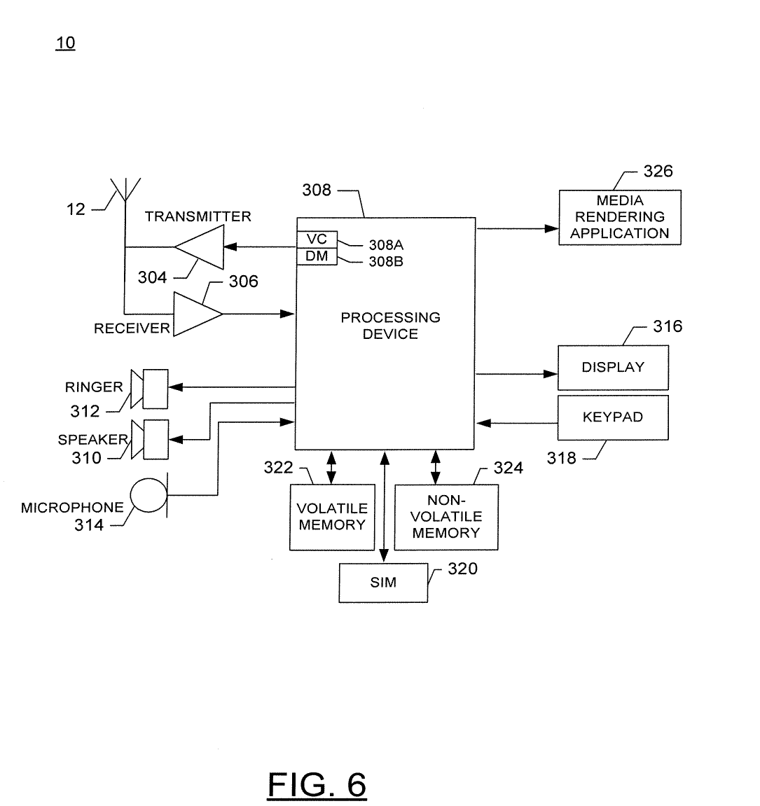

Reference is now made to FIG. 6 which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. In particular, the mobile station includes means for creating, uploading and downloading media diary podcasts in the manner described above in reference to FIGS. 1-3. It should be understood, however, that one or more of the entities may include alternative means for performing one or more like functions, without departing from the spirit and scope of the present invention. More particularly, for example, as shown in FIG. 6, in addition to an antenna 302, the mobile station 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. As noted above, the microphone 314 may be used by a user associated with the mobile station to create one or more narration recordings to be included in a media diary podcast. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. As noted above, at least one of the keys of the keypad may be associated with a media diary application, wherein actuating the key results in the actuation of the media diary application. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code (referred to above as the “media diary application”) for associating an identification with one or more media items consumed using the mobile station, storing context information associated with those media items, and constructing a media diary including the identification and the context information associated with respective media items. In one exemplary embodiment, the mobile station may further comprise a media rendering application 326 configured to enable a user associated with the mobile station to consume one or more media items and, in particular, the one or more media items for which the media diary is being created. The media rendering application 326 of one exemplary embodiment may comprise, for example, a music player, a video player or a gallery application, to name a few.

The method, device, computer program product, system and apparatus of exemplary embodiments of the present invention are primarily described in conjunction with mobile communications applications. It should be understood, however, that the method, device, computer program product, system and apparatus of embodiments of the present invention can be utilized in conjunction with a variety of other applications, both in the mobile communications industries and outside of the mobile communications industries. For example, the method, device, computer program product, system and apparatus of exemplary embodiments of the present invention can be utilized in conjunction with wireline and/or wireless network (e.g., Internet) applications.

### Conclusion:

As described above and as will be appreciated by one skilled in the art, embodiments of the present invention may be configured as a method, device, system and apparatus. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these exemplary embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of creating a media diary, said method comprising:
enabling a user to consume one or more media items;
associating an identification with respective media items consumed;
storing context information associated with respective media items consumed; and
constructing a media diary comprising the identification and the context information associated with respective media items consumed.

2. The method of claim 1 further comprising:
enabling the user to create a narration recording;
assigning an identification to the narration recording; and
determining a time relative to a beginning of the media diary associated with the narration recording, wherein constructing a media diary further comprises constructing a media diary comprising the narration recording, the identification associated with the narration recording, and the time relative to the beginning of the media diary associated with the narration recording.

3. The method of claim 2, wherein enabling the user to create a narration recording comprises recording the user's speech at least one of before, during or after consumption of at least one of the one or more media items.

4. The method of claim 1 further comprising:
enabling the user to select a type of media item for which to create a media diary, wherein associating an identification with respective media items consumed comprises associating an identification with respective consumed media items of the type selected, and wherein storing context information associated with respective media items consumed comprises storing context information associated with respective consumed media items of the type selected.

5. The method of claim 4, wherein the type is selected from a group consisting of a music file, a video file, a still photograph and an e-book.

6. The method of claim 1, wherein enabling a user to consume one or more media items comprises enabling a user to at least one of play a music file, play a video file, view a still photograph or view an e-book.

7. The method of claim 1, wherein associating an identification with respective media objects consumed comprises associating the identification with respective media object consumed within a predefined period of time.

8. The method of claim 1, wherein the context information is selected from a group consisting of a time, a date and a location associated with the corresponding media item consumed.

9. A device configured to create a media diary, said device comprising:
a processor; and
a memory in communication with the processor, said memory storing an application executable by the processor, wherein the application is configured, upon execution, to:
enable a user to consume one or more media items;
associate an identification with respective media items consumed;
store context information associated with respective media items consumed; and
construct a media diary comprising the identification and the context information associated with respective media items consumed.

10. The device of claim 9 further comprising:
a media rendering application stored in the memory and in communication with the processor, said media rendering application configured to enable the user to consume the one or more media items.

11. The device of claim 10, wherein the media rendering application is selected from a group consisting of a music player application, a video player application, a photograph view application, or an e-Book review application.

12. The device of claim 9 further comprising:
a microphone in communication with the processor, wherein the microphone is configured to enable the user to create a narration recording, wherein the application is further configured, upon execution:
assign an identification to the narration recording; and
determine a time relative to a beginning of the media diary associated with the narration recording, wherein constructing a media diary further comprises constructing a media diary comprising the narration recording, the identification associated with the narration recording, and the time relative to the beginning of the media diary associated with the narration recording.

13. The device of claim 12, wherein enabling the user to create a narration recording comprises recording the user's speech at least one of before, during or after consumption of at least one of the one or more media items.

14. The device of claim 9 further comprising:
a user interface configured to enable the user to select a type of media item for which to create a media diary, wherein associating an identification with respective media items consumed comprises associating an identification with respective consumed media items of the type selected, and wherein storing context information associated with respective media items consumed comprises storing context information associated with respective consumed media items of the type selected.

15. The device of claim 14, wherein the type is selected from a group consisting of a music file, a video file, a still photograph and an e-book.

16. The device of claim 9, wherein associating an identification with respective media objects consumed comprises associating the identification with respective media object consumed within a predefined period of time.

17. A computer program product for creating a media diary, wherein the computer program product comprises at least one computer-readable storage medium having computer-readable program code portions stored therein, the computer-readable program code portions comprising:
a first executable portion for enabling a user to consume one or more media items;
a second executable portion for associating an identification with respective media items consumed;
a third executable portion for storing context information associated with respective media items consumed; and
a fourth executable portion for constructing a media diary comprising the identification and the context information associated with respective media items consumed.

18. The computer program product of claim 17, wherein the computer-readable program code portions further comprise:
a fifth executable portion for enabling the user to create a narration recording;
a sixth executable portion for assigning an identification to the narration recording; and
a seventh executable portion for determining a time relative to a beginning of the media diary associated with the narration recording, wherein the fourth executable portion is configured to construct a media diary comprising the narration recording, the identification associated with the narration recording, and the time relative to the beginning of the media diary associated with the narration recording.

19. The computer program product of claim 18, wherein the fifth executable portion is configured to record the user's speech at least one of before, during or after consumption of at least one of the one or more media items.

20. A method of distributing a media file associated with one or more media items, said method comprising:
receiving, at a receiving entity, an identification associated with at least one media item of the media file;
determining whether the at least one media item was previously accessible by the receiving entity; and
requesting and receiving only those of the at least one media item for which it was determined that the media item was not previously accessible by the receiving entity.

21. The method of claim 20 further comprising:
repeating the steps of receiving an identification, determining whether the at least one media item was previously stored, and requesting and receiving only those of the at least one media item for which it was determined that the media item was not previously stored by the receiving entity, for each of the one or more media items of the media file.

22. The method of claim 21 further comprising:
receiving context information associated with respective media items of the media file.

23. The method of claim 22 further comprising:
receiving one or more narration recordings associated with the media file, wherein respective narration recordings comprise a time relative to a beginning of the media file associated with the narration recording.

24. The method of claim 23 further comprising:
accessing one or more media items for which it was determined that the media item was previously accessible by the receiving entity; and
combining the identification associated with respective media items of the media file, the at least one media item requested and received, the one or more media items accessed, the context information associated with respective media items of the media file and the one or more narration recordings into a media podcast file.

25. The method of claim 23 further comprising:
storing the identification associated with respective media items of the media file, the at least one media item requested and received, the context information associated with respective media items of the media file and the one or more narration recordings, separately from the one or more media items for which it was determined that the media item was previously accessible by the receiving entity;
receiving a request for a podcast of the media file from a requester;
determining which of the one or more media items of the media file were previously accessible by the requester; and
assembling a media podcast based at least in part on the determination of which of the one or more media items of the media file were previously accessible by the requester.

26. The method of claim 25 further comprising:
adjusting a charge associated with downloading the media podcast based at least in part on the determination of which of the one or more media items of the media file were previously accessible by the requester.

27. The method of claim 26 further comprising:
enabling a user to remove one or more media items of the media file; and
adjusting the price associated with the download of the media podcast, based at least in part on the one or more media items removed by the user.

28. The method of claim 23, wherein the receiving entity comprises a network entity configured to provide one or more media podcasts for downloading.

29. The method of claim 23, wherein the receiving entity comprises a mobile device configured to access and download one or more media podcasts.

30. The method of claim 29 further comprising:
adjusting a price associating with downloading a media podcast corresponding with the media file based at least in part on the determination of whether the at least one media item was previously accessible by the mobile device.

31. The method of claim 20, wherein the media file comprises a media diary.

32. The method of claim 20, wherein the media file comprises an audio album, and wherein respective media items comprise a music track associated with the audio album.

33. An apparatus for distributing a media file associated with one or more media items, said apparatus comprising:
a processor; and
a memory in communication with the processor, said memory storing an application executable by the processor, wherein the application is configured, upon execution, to:
receive an identification associated with at least one media item of the media file;
determine whether the at least one media item was previously accessible by the apparatus; and
request and receive only those of the at least one media item for which it was determined that the media item was not previously accessible by the apparatus.

34. The apparatus of claim 33, wherein the application is further configured, upon execution, to:
repeat the steps of receiving an identification, determining whether the at least one media item was previously stored, and requesting and receiving only those of the at least one media item for which it was determined that the media item was not previously stored by the apparatus, for each of the one or more media items of the media file.

35. The apparatus of claim 34, wherein the application is further configured, upon execution, to:
receive context information associated with respective media items of the media file.

36. The apparatus of claim 35, wherein the application is further configured, upon execution, to:
receive one or more narration recordings associated with the media file, wherein respective narration recordings comprise a time relative to a beginning of the media file associated with the narration recording.

37. The apparatus of claim 36, wherein the application is further configured, upon execution, to:
access one or more media items for which it was determined that the media item was previously accessible by the apparatus; and
combine the identification associated with respective media items of the media file, the at least one media item requested and received, the one or more media items accessed, the context information associated with respective media items of the media file and the one or more narration recordings into a media podcast file.

38. The apparatus of claim 36, wherein the application is further configured, upon execution, to:
store the identification associated with respective media items of the media file, the at least one media item requested and received, the context information associated with respective media items of the media file and the one or more narration recordings, separately from the one or more media items for which it was determined that the media item was previously accessible by the apparatus;
receive a request for a podcast of the media file from a requester;
determine which of the one or more media items of the media file were previously accessible by the requester; and
assemble a media podcast based at least in part on the determination of which of the one or more media items of the media file were previously accessible by the requester.

39. The apparatus of claim 38, wherein the application is further configured, upon execution, to:
adjust a charge associated with downloading the media podcast based at least in part on the determination of which of the one or more media items of the media file were previously accessible by the requester.

40. The apparatus of claim 39, wherein the application is further configured, upon execution, to:
enable a user to remove one or more media items of the media file; and
adjust the price associated with the download of the media podcast, based at least in part on the one or more media items removed by the user.

41. The apparatus of claim 36, wherein the apparatus comprises a network entity configured to provide one or more media podcasts for downloading.

42. The apparatus of claim 36, wherein the apparatus comprises a mobile device configured to access and download one or more media podcasts.

43. The apparatus of claim 42, wherein the application is further configured, upon execution, to:
adjust a price associating with downloading a media podcast corresponding with the media file based at least in part on the determination of whether the at least one media item was previously accessible by the mobile device.

44. A system for distributing a media file, said media file associated with one or more media items, said system comprising:
a transmitting entity configured to transmit an identification associated with at least one media item of the media file; and
a receiving entity configured to receive the at least one identification and to determine whether the at least one media item was previously accessible by the receiving entity, wherein the receiving entity is further configured to request and receive, from the transmitting entity, only those of the at least one media item for which it was determined that the media item was not previously accessible by the receiving entity.

45. The system of claim 44, wherein the transmitting entity comprises a network entity configured to provide one or more media podcasts for downloading, and wherein the receiving entity comprises a mobile device configured to download one or more media podcasts from the network entity.

46. The system of claim 44, wherein the transmitting entity comprises a mobile device configured to generate and upload one or more media files, and wherein the receiving entity comprises a network entity configured to receive the one or more media files from the mobile device.

47. A computer program product for distributing a media file, said media file associated with one or more media items, wherein the computer program product comprises at least one computer-readable storage medium having computer-readable program code portions stored therein, the computer-readable program code portions comprising:
a first executable portion for receiving, at a receiving entity, an identification associated with at least one media item of the media file;
a second executable portion for determining whether the at least one media item was previously accessible by the receiving entity; and
a third executable portion for requesting and receiving only those of the at least one media item for which it was determined that the media item was not previously accessible by the receiving entity.

48. The computer program product of claim 47, wherein the computer-readable program code portions further comprise:
a fourth executable portion for repeating the steps of receiving an identification, determining whether the at least one media item was previously stored, and requesting and receiving only those of the at least one media item for which it was determined that the media item was not previously stored by the receiving entity, for each of the one or more media items of the media file.

49. The computer program product of claim 48, wherein the computer-readable program code portions further comprise:
a fifth executable portion for receiving context information associated with respective media items of the media file.
